(19) United States
(12) Patent Application Publication
(10) Pub. No.: US 2009/0135634 A1
(43) Pub. Date: May 28, 2009

(54) Synchronous rectifier drive circuit

(75) Inventors: Lien-Hsing Chen, Taichung County (TW); Li-Hao Liu, Taichung (TW)

Correspondence Address: BACON & THOMAS, PLLC, 625 SLATERS LANE, FOURTH FLOOR, ALEXANDRIA, VA, 22314-1176, US

(73) Assignee: POWER MATE TECHNOLOGY CO., LTD., TAICHUNG (TW)

(21) Appl. No.: 12/071,954

(22) Filed: Feb. 28, 2008

(30) Foreign Application Priority Data
Nov. 23, 2007 (TW) 96219877

(51) Int. Cl. H02M 7/217

(52) U.S. Cl. 363/127

(57) ABSTRACT

A synchronous rectifier drive circuit includes a primary side and a secondary side. The primary side has a first coil winding, a first MOSFET, an auxiliary MOSFET, an auxiliary capacitor, and an input power source. The secondary side has a second coil winding, a DC voltage source, a second MOSFET, a third MOSFET, a fourth MOSFET, a fifth MOSFET, and an inductor. The gate of the second MOSFET is connected with the source of the fourth MOSFET. The gate of the third MOSFET is connected with the source of the fifth MOSFET. The inductor has two ends, one of which is connected with the drain of the third MOSFET. Accordingly, the synchronous rectifier drive circuit can lessen the variation of pulse wave of the drive voltage and refrain the surge voltage to protect the electronic elements.

### BACKGROUND OF THE INVENTION

1. Field of the Invention

The present invention relates generally to electronic circuits, and more particularly, to a DC/DC synchronous rectifier drive circuit.

2. Description of the Related Art

As shown in FIG. 6, a conventional DC/DC self-excited conversion drive circuit includes auxiliary coil windings N3, N4 & N5 as well as two coil windings located at two sides of a transformer and cooperates with a forward switch Q2 and a flywheel switch Q3 to do DC/DC conversion.

FIG. 7(A) shows the waveform as the aforesaid circuit is operated, illustrating that the positive drive voltage level of the forward switch Q2 becomes high as the input voltage increases, and however, the positive drive voltage level of the flywheel switch Q3 becomes low and the negative drive voltage level of the same becomes high as the input voltage increases.

FIG. 7(B) illustrates that the surge voltage of the drive voltage of the forward switch Q2 reaches 27V (one indication denotes 2V) and the negative surge voltage of the drive voltage of the flywheel switch Q3 exceeds −20V. However, the maximum working voltage that the gate/source of the general power field-effect transistor can withstand is ±20V. Therefore, the surge voltage tends to cause punch-through and burnout of the gate/source.

### SUMMARY OF THE INVENTION

The primary objective of the present invention is to provide a synchronous rectifier drive circuit, which prevents negative drive voltage from occurrence to lessen the variation of pulse wave of the drive voltage.

The secondary objective of the present invention is to provide a synchronous rectifier drive circuit, which prevents the surge voltage from occurrence to protect the electronic elements.

The foregoing objectives of the present invention are attained by the synchronous rectifier drive circuit, which includes a primary side and a secondary side. The primary side includes a first coil winding, a first metal oxide semiconductor field-effect transistor (MOSFET), an auxiliary MOSFET, an auxiliary capacitor, and an input power source. The auxiliary MOSFET and the auxiliary capacitor are connected in series and then connected in parallel with the first coil winding. The first MOSFET and the input power source are connected in series and then connected in parallel with the first coil winding. The secondary side includes a second coil winding, a DC voltage source, a second MOSFET, a third MOSFET, a fourth MOSFET, a fifth MOSFET, and an inductor. Each of the MOSFETs is provided with a gate, a drain, and a source. The DC voltage source is connected with the gate of the fourth MOSFET and the gate of the fifth MOSFET. The drains of the fourth and fifth MOSFETs are connected with two ends of the second coil winding respectively. The gate of the second MOSFET is connected with the source of the fourth MOSFET. The gate of the third MOSFET is connected with the source of the fifth MOSFET. The drain of the third MOSFET is connected with the drain of the fourth MOSFET. The drain of the second MOSFET is connected with the drain of the fifth MOSFET. The source of the second MOSFET is connected with the source of the third MOSFET. The inductor has two ends, one of which is connected with the drain of the third MOSFET and the other as well as the source of the third MOSFET is connected with a load.

### BRIEF DESCRIPTION OF THE DRAWINGS

FIG. 1 is a circuit diagram of a preferred embodiment of the present invention.

FIG. 2 is an oscillogram of the preferred embodiment of the present invention, showing the characteristic curves as the N-channel enhancement mode MOSFET is turned on.

FIG. 3 is a timing diagram of the preferred embodiment of the present invention.

FIG. 4 is a timing diagram view of the preferred embodiment of the present invention, showing the time sections before the time to.

FIG. 5 is an oscillogram of the preferred embodiment of the present invention, showing the waveforms of voltages of gates/sources of the second and third MOSFETs.

FIG. 6 is a circuit diagram of the conventional DC/DC conversion circuit.

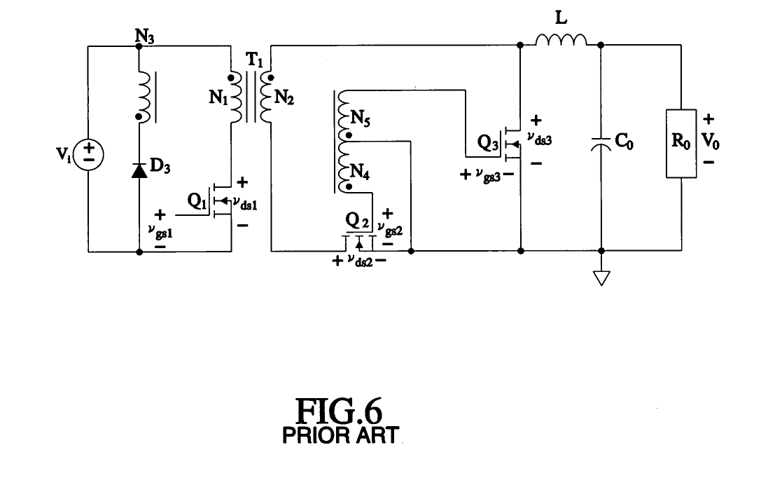

FIG. 7 is an oscillogram of the conventional DC/DC conversion circuit.

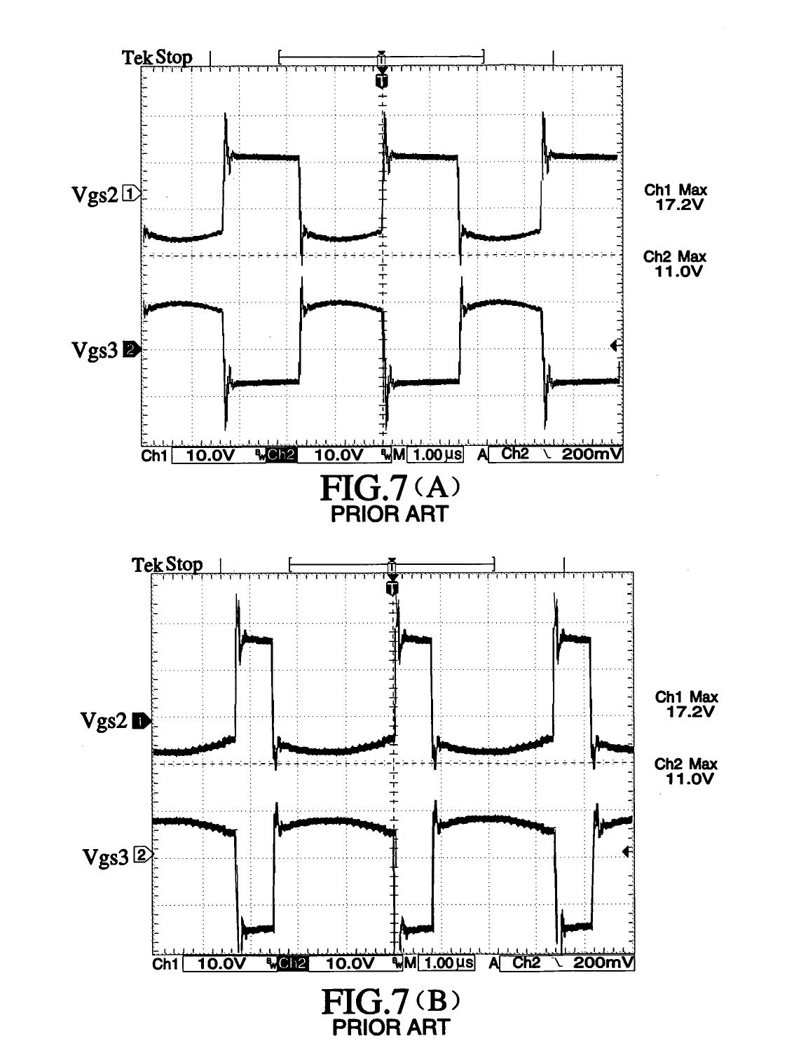

### DETAILED DESCRIPTION OF PREFERRED EMBODIMENTS

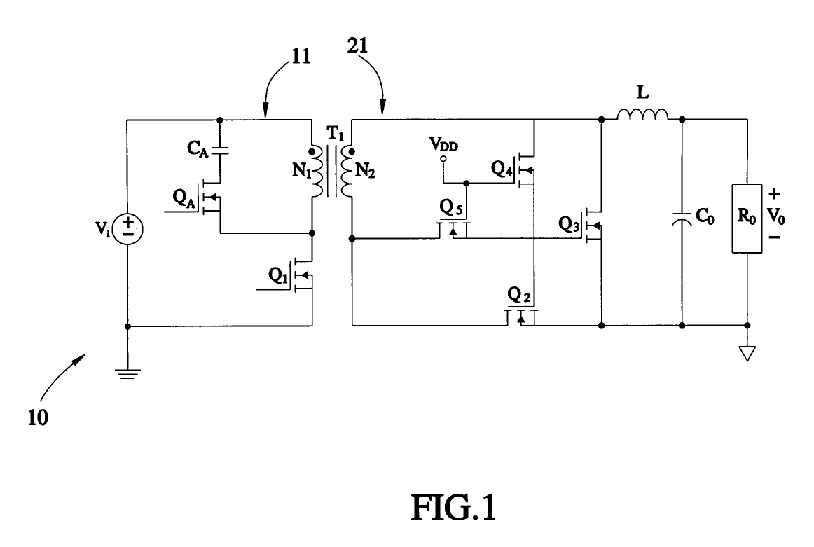

Referring to FIG. 1, a synchronous rectifier circuit 10 includes a primary side 11 and a secondary side 21.

The primary side 11 includes a first coil winding N₁, a first MOSFET Q₁, an auxiliary MOSFET Q_{A}, an auxiliary capacitor C_{A}, and an input power source Vᵢ. Each of the first MOSFET Q₁ and the auxiliary MOSFET Q_{A} is provided with a gate, a drain, and a source. The auxiliary MOSFET Q_{A} and the auxiliary capacitor C_{A} are connected in series and then connected in parallel with the first coil winding N₁; specifically, the drain of auxiliary MOSFET Q_{A} is connected with one end of the auxiliary capacitor C_{A}, and the other end of auxiliary capacitor C_{A} and the source of auxiliary MOSFET Q_{A} are connected in parallel with the first coil winding N₁. The first MOSFET Q₁ and the input power source Vᵢ are connected in series and then connected in parallel with first coil winding N₁; specifically, the source of the first MOSFET Q₁ is connected with an negative electrode of the input power source Vᵢ, and a positive electrode of the input power source Vᵢ and the drain of the first MOSFET Q₁ are connected in parallel with first coil winding N₁.

The secondary side 21 includes a second coil winding N₂, a DC voltage source V_{DD}, a second MOSFET Q₂, a third MOSFET Q₃, a fourth MOSFET Q₄, a fifth MOSFET Q₅, and an inductor L. Each of the second, third, fourth, and fifth MOSFETs Q₂, Q₃, Q₄, and Q₅ includes a gate, a drain, and a source. The DC voltage source V_{DD} is connected with the gate of the fourth MOSFET Q₄ and the gate of the fifth MOSFET Q₅. The drain of the fourth MOSFET Q₄ and the drain of the fifth MOSFET Q₅ are connected with two ends of the second coil winding N₂ respectively. The gate of the second MOSFET Q₂ is connected with the source of the fourth MOSFET Q₄. The gate of the third MOSFET Q₃ is connected with the source of the fifth MOSFET Q₅. The drain of the third MOSFET Q₃ is connected with the drain of the fourth MOSFET Q₄. The drain of the second MOSFET Q₂ is connected with the drain of the fifth MOSFET Q₅. The source of the second MOSFET Q₂ is connected with the source of the third MOSFET Q₃. The inductor L has two ends, one of which is connected with the drain of the third MOSFET Q₃ and the other is connected with one end of a load R_{O}. The source of the third MOSFET Q₃ is connected with the other end of the load R_{O}. An input capacitor C_{O} is connected in parallel with the load R_{O}.

The first and second coil windings N₁ and N₂ are located at two sides of a transformer T₁; specifically, the first coil winding N₁ is located at the primary side of the transformer T₁ and the second coil winding N₂ is located at the secondary side of the transformer T₁.

As shown in FIG. 1, because the field-effect transistor is turned on only when its voltage level of the gate/source is greater than the threshold voltage, the voltage levels of the gates of the fourth and fifth MOSFETs Q₄ and Q₅ keep the same as the DC voltage of the DC voltage source V_{DD} to keep being turned on.

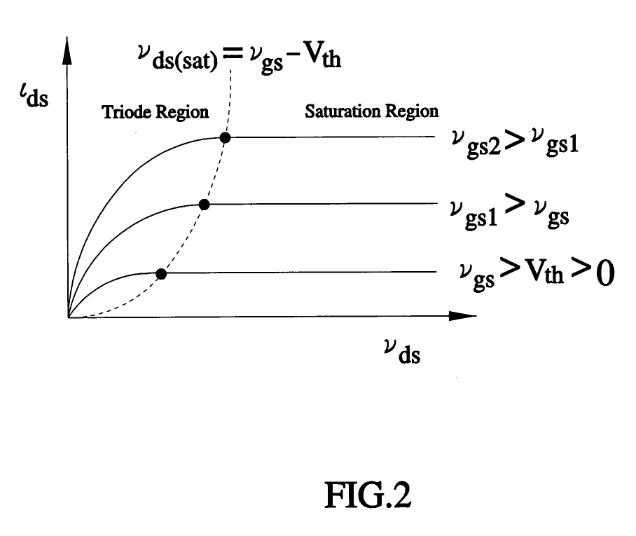

FIG. 2 depicts the characteristic curves as an N-channel enhancement mode MOSFET is turned on. When the V_{ds} is less than V_{ds(sat)}, it is called “Triode Region”. When the V_{ds} is greater than V_{ds(sat)}, it is called “Saturation Region”. Therefore, the fourth and fifth MOSFETs Q₄ and Q₅ are switched between the triode region and the saturation region, wherein V_{ds} is denoted by the following equation (1):

V_{ds(sat)}=V_{gs}−Vₜₕ (1)

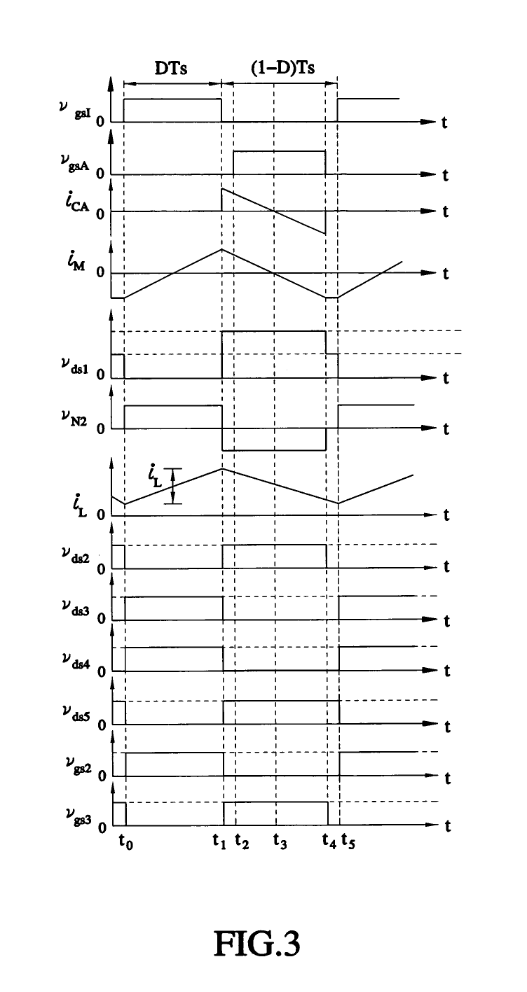

Referring to FIG. 3 as well as FIG. 1, the timing diagram of the FIG. 3 can be illustrated by the following five time sections and it is presumed that the operation is under continuous-current mode and ideal condition of the elements.

1. Time Section [t₀-t₁]:

When the time is equal to, the first MOSFET Q₁ is turned on and the auxiliary MOSFET Q_{A} is cut off. It is presumed that the first coil winding Q₁ has an exciting inductance L_{M} and an exciting current i_{M}. In the meantime, the exciting inductance L_{M} stands for the status of energy storage, and the span voltage between two ends of V_{N1} is denoted by the following equation (2):

v_{N1}=Vᵢ (2)

Because the polarity of V_{N2} is identical to that of V_{N1}, we get the following equation (3):

$${v}_{N2} = \frac{{N}_{2}}{{N}_{1}} {V}_{i} \qquad ( 3 )$$

As known from the equation (1), the fifth MOSFET Q₅ is operated in the triode region under the condition denoted by the following equation (4):

V_{ds5}<V_{ds5(sat)}=V_{gs5}−V_{th(Q5)} (4)

In the equation (4), V_{gs5} is denoted by the following equation (5):

V_{gs5}=V_{DD}−V_{gs3} (5)

Substituting the equation (5) into the equation (4), we get the following equation (6):

V_{ds5}+V_{gs3}=V_{ds2}<V_{DD}−V_{th(Q5)} (6)

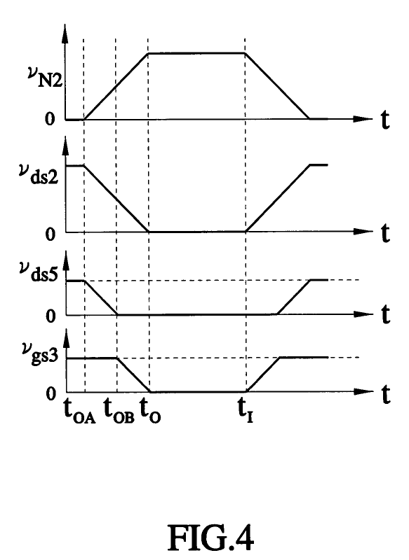

As shown in FIG. 4, what is before the time point T₀ is partitioned into two time sections to illustrate the operating principle of the present invention. When the time section is between T_{0A} and T_{0B}, V_{ds2} is greater than (V_{DD}−V_{th(Q5)}), so the fifth MOSFET Q₅ is operated at the saturation region. When the time section is between T_{0B} and T₀, V_{ds2} is less than (V_{DD}−V_{th(Q5)}), so the fifth MOSFET Q₅ is turned on and operated at the triode region. Suppose i_{ds(Q5)} is equal to zero under the ideal condition, so V_{ds5} is also equal to zero, and meanwhile, V_{gs3} is equal to V_{ds2}. When V_{ds2} is dropped to zero, the third MOSFET Q₃ is cut off. The drain/source of the third MOSFET Q₃ is denoted by the following equation (7):

V_{ds3}=V_{N2} (7)

The fourth MOSFET Q₄ is originally operated at the triode region, so v_{gs2} rises as v_{ds3} rises and the second MOSFET Q₂ is turned on. When v_{ds3} is greater than (V_{DD}−V_{th(Q4)}), the operation of the fourth MOSFET Q₄ is changed from the triode region to the saturation region; meanwhile, v_{ds4} rises gradually and the voltage level of v_{gs2} is maintained at (V_{DD}−V_{th(Q4)}), so v_{ds4} is denoted by the following equation (8):

$${v}_{ds 4} = {v}_{ds 3} - {v}_{gs 2} = \frac{{N}_{2}}{{N}_{1}} {V}_{i} - {V}_{DD} + {V}_{th ( Q 4 )} \qquad ( 8 )$$

2. Time Section [t₁-t₂]:

In this time section, the first MOSFET Q₁ is cut off and the exciting inductance L_{M} is at the exoergic status. Because the auxiliary MOSFET Q_{A} keeps being cut off, the exciting current i_{M} is turned on via the parasitic diode of the auxiliary MOSFET Q_{A} to charge the auxiliary capacitor C_{A}. The span voltage v_{ds1} and the current i_{CA} are denoted respectively by the following equations (9) and (10):

v_{ds1}=Vᵢ+V_{CA} (9)

i_{CA}=i_{M} (10)

In the meantime, the span voltage V_{N1} is denoted by the following equation (11):

V_{N1}−V_{CA} (11)

Because V_{N2} has the same polarity as V_{N1} does, V_{N2} can be denoted by the following equation (12):

$${V}_{N 2} = - \frac{{N}_{2}}{{N}_{1}} {V}_{CA} \qquad ( 12 )$$

Because v_{ds3} is dropped to zero at the moment, the fourth MOSFET Q₄ enters the triode region, v_{gs2} is dropped to zero as well and the second MOSFET Q₂ is cut off. The voltage v_{ds2} rises, v_{gs3} rises together with v_{ds2}, the third MOSFET Q₃ is turned on, and the fifth MOSFET Q₅ is operated from the triode region to the saturation region. At the moment, the span voltage v_{ds2} is denoted by the following equation (13):

$${v}_{ds 2} = - {v}_{N 2} = \frac{{N}_{2}}{{N}_{1}} {V}_{CA} \qquad ( 13 )$$

Therefore, v_{ds5} can be denoted by the following equation (14):

$${v}_{ds 5} = {v}_{ds 2} - {v}_{gs 3} = \frac{{N}_{2}}{{N}_{1}} {V}_{CA} - {V}_{DD} + {V}_{th ( Q 5 )} \qquad ( 14 )$$

In the meantime, the indictor L starts to shift to the discharging status.

3. Time Section [t₂-t₃]:

In this time section, the auxiliary MOSFET Q_{A} is turned on and the auxiliary capacitor C_{A} keeps being charged and then be fully charged until the time point t₃; meanwhile, both of i_{M} and i_{CA} are dropped to zero. The secondary side of the transformer T₁ has the same status in this time section as in the previous time section [t₁-t₂].

4. Time Section [t₃-t₄]:

The auxiliary MOSFET Q_{A} keeps being turned on and the auxiliary capacitor C_{A} starts to reversely magnetize the exciting inductor L_{M} to produce reverse exciting current, and then the curve B-H of the transformer T₁ falls in the third quadrant. The secondary side of the transformer T₁ has the same status in this time section as in the previous time section [t₂-t₃] does.

5. Time Section [t₄-t₅]:

The auxiliary MOSFET Q_{A} is cut off, the auxiliary capacitor C_{A} stops discharging, and both of i_{M} and i_{CA} are dropped to zero; meanwhile, the span voltage V_{N2} is zero and the third MOSFET Q₃ is cut off because the drive voltage is dropped to zero. The current of the inductor L is turned on via the parasitic diode of the third MOSFET Q₃ and keeps discharging until the next time point. That is, the whole operation repeats from the time point to recursively.

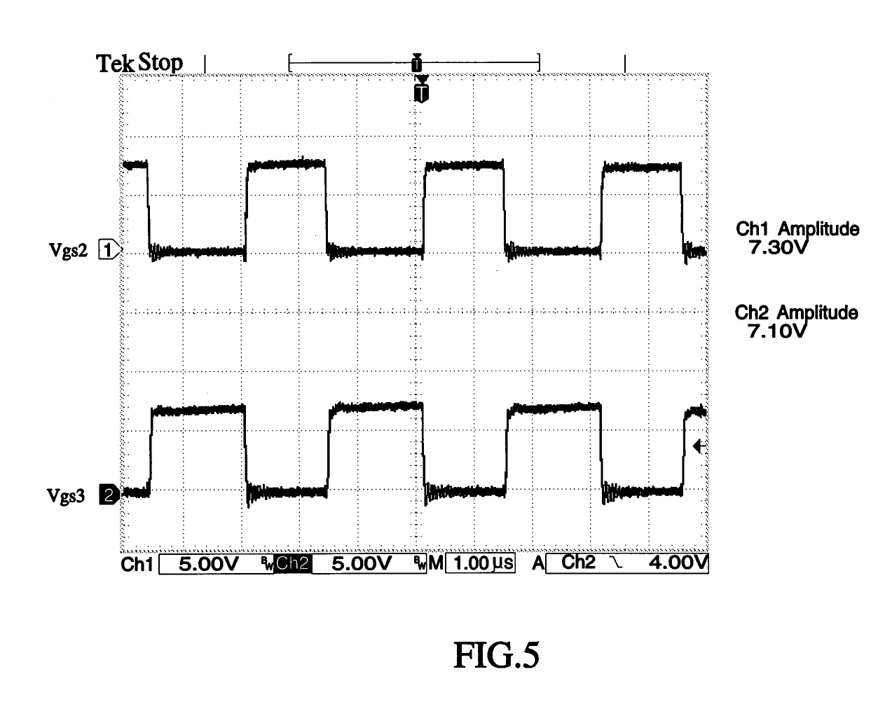

FIG. 5 illustrates the waveform of the drive voltage of the present invention, showing that there is no negative drive voltage and no surge voltage above the positive drive voltage, and the drive voltage levels of the input voltages from the highest to the lowest keep between 6V_{DC} and 8V_{DC} and thus will not exceed the maximum withstanding voltage (±20V) of the gate/source of the general power field-effect transistor.

In conclusion, the present invention can lessen the variation of pulse wave of the drive voltage and to restrain the surge voltage, thus protecting the electronic elements.

Although the present invention has been described with respect to a specific preferred embodiment thereof, it is no way limited to the details of the illustrated structures but changes and modifications may be made within the scope of the appended claims.

What is claimed is:

1. A synchronous rectifier circuit comprising:
a primary side having a first coil winding, a first MOSFET, an auxiliary MOSFET, an auxiliary capacitor, and an input power source, said auxiliary MOSFET and said auxiliary capacitor being connected in series and then connected in parallel with said first coil winding, said first MOSFET and said input power source being connected in series and then connected in parallel with said first coil winding; and
a secondary side having a second coil winding, a DC voltage source, a second MOSFET, a third MOSFET, a fourth MOSFET, a fifth MOSFET, and an inductor, said DC voltage source being connected with a gate of said fourth MOSFET and a gate of said fifth MOSFET, drains of said fourth MOSFET and said fifth MOSFET being connected with two ends of said second coil winding respectively, a gate of said second MOSFET being connected with a source of said fourth MOSFET, a gate of said third MOSFET being connected with a source of said fifth MOSFET, a drain of said third MOSFET being connected with the drain of said fourth MOSFET, a drain of said second MOSFET being connected with the drain of said fifth MOSFET, a source of said second MOSFET being connected with a source of said third MOSFET, said inductor having two ends, one of which is connected with said third MOSFET and the other is connected with an end of a load, the source of said third MOSFET being connected with the other end of said load.

2. The synchronous rectifier circuit as defined in claim 1, wherein said first coil winding and said second coil winding are located at two sides of a transformer respectively, said first coil winding being located at a primary side of said transformer, said second coil winding being located at a secondary side of said transformer.

3. The synchronous rectifier circuit as defined in claim 1, wherein said auxiliary MOSFET at the drain is connected with an end of said auxiliary capacitor, the other end of said auxiliary capacitor and a source of said auxiliary MOSFET are connected in parallel with said first coil winding.

4. The synchronous rectifier circuit as defined in claim 1, wherein said first MOSFET at the source is connected with a negative electrode of said input power source, a positive electrode of said input power source and a drain of said first MOSFET are connected in parallel with said first coil winding.
